(19) United States
(12) Patent Application Publication
(10) Pub. No.: US 2016/0328276 A1
(43) Pub. Date: Nov. 10, 2016

(54) SYSTEM, INFORMATION PROCESSING DEVICE, AND METHOD

(71) Applicant: FUJITSU LIMITED, Kawasaki-shi (JP)

(72) Inventors: Teruo Tanimoto, Kawasaki (JP); TAKASHI MIYOSHI, Ohta (JP)

(73) Assignee: FUJITSU LIMITED, Kawasaki-shi (JP)

(21) Appl. No.: 15/139,954

(22) Filed: Apr. 27, 2016

(30) Foreign Application Priority Data
May 8, 2015 (JP) 2015-095543

(51) Int. Cl. G06F 9/52; G06F 12/08; G06F 13/24

(52) U.S. Cl. CPC G06F 9/526; G06F 13/24; G06F 12/0877; G06F 2212/603

(57) ABSTRACT

A system includes: a first device configured to transmit a first request; and a second device coupled to the first device, the second device including a processor configured to execute a program, a memory, and a communicating device. The communicating device is configured to: receive the first request, when a lock variable is not stored at a given address in the memory, write the lock variable at the given address, and perform processing of the first request, and when the communicating device is unable to write the lock variable at the given address within a set time due to the lock variable stored at the given address, notify an interrupt to the program, and hand over the processing of the first request to the processor.

### CROSS-REFERENCE TO RELATED APPLICATION

This application is based upon and claims the benefit of priority of the prior Japanese Patent Application No. 2015-095543, filed on May 8, 2015, the entire contents of which are incorporated herein by reference.

### FIELD

The embodiments discussed herein are related to a system, an information processing device, and a method.

### BACKGROUND

A method referred to as a remote procedure call (RPC) that makes an information processing device coupled via a network execute a program has been proposed to effectively utilize resources of the information processing device. In the RPC, on the basis of reception of a request from another information processing device via the network, a communication interface unit of the information processing device performs interrupt processing to thereby make a processor start a request processing program and perform processing based on the request.

As a related art, it is known that an information processing device that transmits an RPC request suspends an RPC program after transmitting the request until completion of processing of the RPC request. Another program can be executed by suspending the RPC program.

As another related art, it is known that an image processing device including a software processing unit and a hardware processing unit performs image processing in one of the software processing unit and the hardware processing unit which has a shorter processing time on the basis of an instruction from a user.

As another related art, it is known that a communication interface unit that has received a packet indicating an atomic operation performs the chained atomic operation in place of a processor. This may eliminate overhead of interrupt processing and the like of the processor which overhead occurs each time data is transmitted or received.

Japanese Laid-open Patent Publication Nos. 1994-259380, 2002-74331, and 2007-316955 are known as an example of the related arts.

### SUMMARY

According to an aspect of the invention, a system includes a first device configured to transmit a first request; and a second device coupled to the first device, the second device including a processor configured to execute a program, a memory, and a communicating device, wherein the communicating device is configured to: receive the first request, when a lock variable is not stored at a given address in the memory, write the lock variable at the given address, and perform processing of the first request, and when the communicating device is unable to write the lock variable at the given address within a set time due to the lock variable stored at the given address, notify an interrupt to the program, and hand over the processing of the first request to the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one embodiment;

FIG. 2 illustrates an example of operation of a communicating device;

FIG. 3 illustrates another embodiment;

FIG. 4 illustrates an example of a network interface controller (NIC) in a processing node;

FIG. 5 illustrates an example of an NIC in a client node;

FIG. 6 illustrates an example of a data structure of data stored in a data area accessed on the basis of an RPC request;

FIG. 7 illustrates an example of a connection management table;

FIG. 8 illustrates an example of functions used for RPCs;

FIG. 9 illustrates an example of operation in a case where an NIC of a processing node receives a packet from a client node;

FIG. 10 illustrates an example of operation in a case where an NIC of a processing node receives a packet from a central processing unit (CPU);

FIG. 11 illustrates an example of operation in a case where an NIC of a client node receives a packet;

FIG. 12 illustrates an example of operation of an information processing system;

FIG. 13 illustrates another example of operation of the information processing system;

FIG. 14 illustrates another example of operation of the information processing system;

FIG. 15 illustrates another example of operation of the information processing system;

FIG. 16 illustrates an example of RPC request processing time with respect to waiting time before an NIC obtains a lock in an information processing system; and

FIG. 17 illustrates an example of throughput as compared with processing by a CPU in an information processing system.

### DESCRIPTION OF EMBODIMENTS

When either a processor or a communication interface unit processes an RPC request in an information processing device, exclusive processing based on a lock obtaining operation or the like is performed to maintain the consistency of processed data. However, when the communication interface unit processes an RPC request, the longer a waiting time before obtainment of a lock, the longer a time before completion of the processing. Until completion of the processing of the request, the communication interface unit puts processing of another request on hold. Therefore, when the waiting time before obtainment of the lock is longer than a given time, processing efficiency is decreased as compared with a case where the RPC request is processed by the processor, and consequently the performance of an information processing system including the information processing device is decreased.

In one aspect, it is an object of the technology disclosed herein to improve request processing efficiency by processing a request in either an arithmetic processing device or a communicating device according to a time before obtainment of a lock.

Embodiments will hereinafter be described with reference to the drawings.

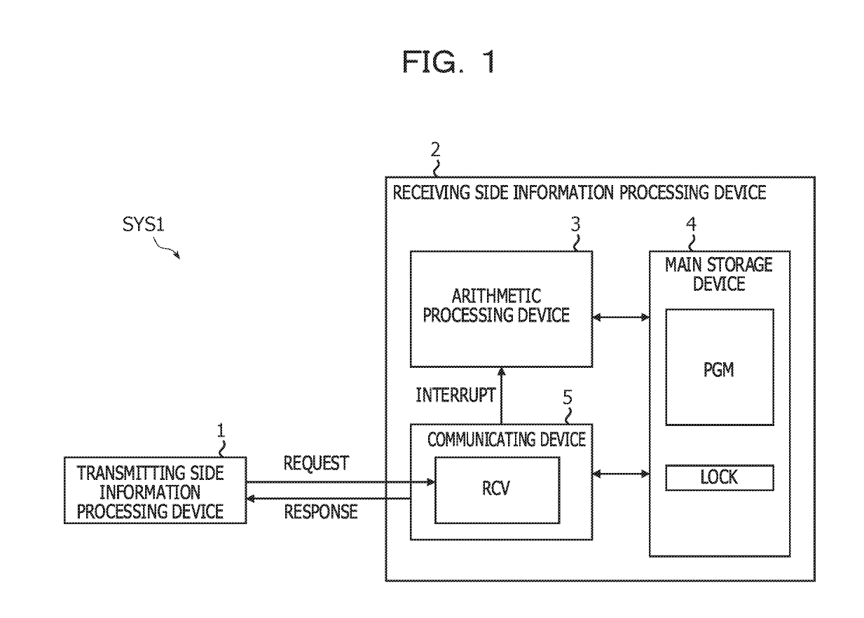

FIG. 1 illustrates one embodiment. An information processing system SYS1 illustrated in FIG. 1 includes a transmitting side information processing device 1 and a receiving side information processing device 2 coupled to the transmitting side information processing device 1. For example, the transmitting side information processing device 1 is a server such as a client node issuing a request, and the receiving side information processing device 2 is a server such as a processing node coupled to the client node via a network and processing the request. That is, the information processing system SYS1 operates as a distributed processing system having a function of processing a request by an RPC.

The receiving side information processing device 2 includes an arithmetic processing device 3 that executes a program PGM, a main storage device 4 that stores the program PGM and a lock variable LOCK at given addresses, and a communicating device 5 that includes a receiving unit RCV receiving a request from the transmitting side information processing device 1. When the receiving unit RCV receives a request, and the lock variable LOCK is not stored at the given address, the communicating device 5 writes the lock variable LOCK at the given address, and processes the request. After completing the processing of the request, the communicating device 5 transmits a response to the request to the transmitting side information processing device 1. Incidentally, the processing of writing the lock variable LOCK when the lock variable LOCK is not stored will be referred to also as the obtainment of a lock.

When the receiving unit RCV receives a request, and the lock variable LOCK is stored at the given address, the communicating device 5 waits to process the request until the lock variable LOCK is initialized. The lock variable LOCK is used for the arithmetic processing device 3 or the communicating device 5 to exclusively process the request.

In the following, the state in which the lock variable LOCK is written will be referred to also as a locked state, and the initialized state in which the lock variable LOCK is not written will be referred to also as a released state. The processing of the request is performed by a device (the arithmetic processing device 3 or the communicating device 5) that sets the lock variable LOCK in the released state to the locked state.

When it is difficult for the communicating device 5 to write the lock variable LOCK to the given address within a given time because the lock variable LOCK is already stored at the given address (locked state), on the other hand, the communicating device 5 notifies an interrupt to the program PGM being executed by the arithmetic processing device 3. The arithmetic processing device 3 performs interrupt processing on the basis of the notification of the interrupt, and processes the request by executing the program PGM. That is, when the lock variable LOCK is not changed from the locked state to the released state within a given time from reception of the request, the communicating device 5 hands over the processing of the request to the arithmetic processing device 3. The arithmetic processing device 3 performs the processing of the request handed over from the communicating device 5, and transmits a response to the request to the communicating device 5. The communicating device 5 transmits the response to the request which response is received from the arithmetic processing device 3 to the transmitting side information processing device 1.

When the locked state of the lock variable LOCK continues for a given time or more, the processing of the request is handed over to the arithmetic processing device 3. Thus, the communicating device 5 can process another request received by the receiving unit RCV, and the receiving unit RCV can receive a new request. Therefore, as compared with a case of waiting to process the request until the obtainment of the lock without setting the given time, request processing efficiency is improved, and consequently the processing performance of the information processing system SYS1 is improved.

Further, when the lock variable LOCK can be written within the given time, the communicating device 5 itself processes the request. Thus, a time taken by the arithmetic processing device 3 to perform interrupt processing and the like is saved, and the processing of the request is performed efficiently.

In the case where the communicating device 5 waits to process the request until the obtainment of the lock without setting the given time, on the other hand, when it takes time to obtain the lock, it is difficult to receive a new request by the receiving unit RCV, and the communicating device 5 may fall into a stalled state. This decreases the processing performance of the information processing system SYS1 as compared with the case where the given time is set and the processing of the request is handed over to the arithmetic processing device 3. In addition, when the arithmetic processing device 3 processes remote procedure processing requests at all times, the communicating device 5 notifies an interrupt to the arithmetic processing device 3 each time the communicating device 5 receives a request, and the arithmetic processing device 3 performs interrupt processing each time the arithmetic processing device 3 processes a request. The efficiency of request processing in the arithmetic processing device 3 when interrupt processing is involved is decreased as compared with the case where request processing is performed by using the communicating device 5.

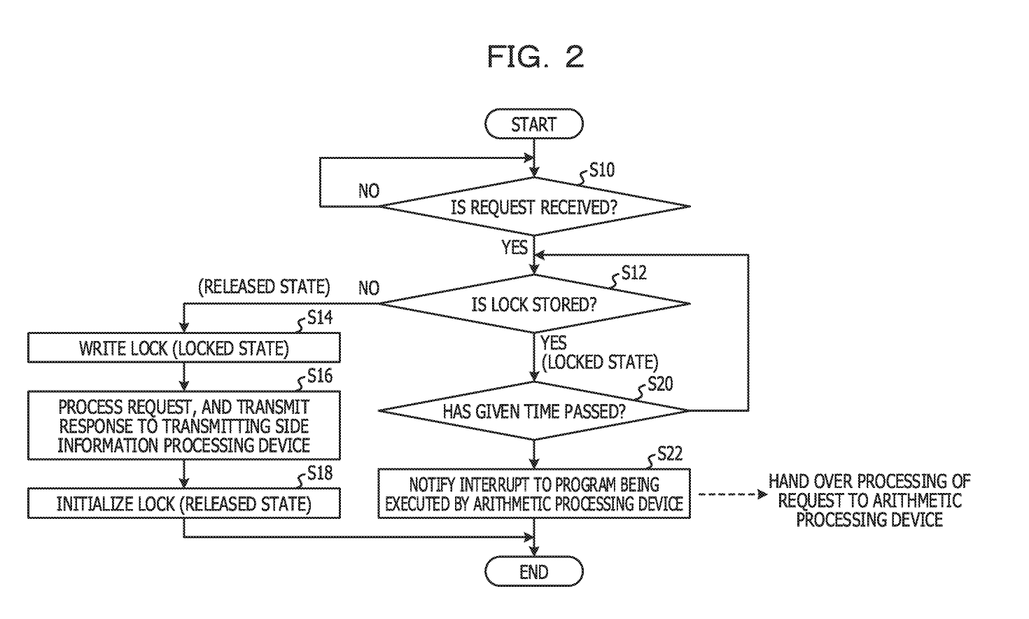

FIG. 2 illustrates an example of operation of a communicating device. The operation illustrated in FIG. 2 may be performed by hardware of the communicating device, or may be performed by software executed by the communicating device. FIG. 2 illustrates a control method of an information processing system. The communicating device and the information processing system described with reference to FIG. 2 may be the communicating device 5 and the information processing system SYS1 illustrated in FIG. 1, respectively.

First, in step S10, the communicating device 5 waits to receive a request from the transmitting side information processing device 1. When the communicating device 5 receives a request, the communicating device 5 makes the operation proceed to step S12. In step S12, when the lock variable LOCK is stored in the main storage device 4 (Yes at step S12: locked state), the communicating device 5 makes the operation proceed to step S20, or when the lock variable LOCK is not stored in the main storage device 4 (No at step S12: released state), the communicating device 5 makes the operation proceed to step S14.

In step S14, the communicating device 5 writes the lock variable LOCK, and thereby changes the state of the lock variable LOCK from the released state to the locked state. Next, in step S16, the communicating device 5 processes a remote procedure processing request received from the transmitting side information processing device 1, and transmits a response to the request to the transmitting side information processing device 1. The processing of the request is for example the writing of data to the main storage device 4 based on the request or the reading of data from the main storage device 4 based on the request. Incidentally, the processing of the request may include data processing such as an arithmetic operation. Next, in step S18, the communicating device 5 sets the lock variable LOCK to the released state by initializing the lock variable LOCK. The communicating device 5 then ends the operation. That is, the communicating device 5 waits to receive a request in step S10 again. The initialization of the lock variable LOCK after completion of the processing of the request enables the communicating device 5 or the arithmetic processing device 3 to process another request.

When the locked state is determined in step S12, on the other hand, the communicating device 5 in step S20 determines whether or not the given time has passed since the reception of the request. When the given time has passed, the communicating device 5 determines that it is difficult to obtain the lock, and makes the operation proceed to step S22. When the given time has not passed, the communicating device 5 returns the operation to step S12.

In step S22, the communicating device 5 hands over the processing of the request to the arithmetic processing device 3 by notifying an interrupt to the program PGM being executed by the arithmetic processing device 3. The communicating device 5 then ends the operation. That is, the communicating device 5 waits to receive a request in step S10 again.

As described above, the embodiment illustrated in FIG. 1 and FIG. 2 improves request processing efficiency by processing a request in either the arithmetic processing device 3 or the communicating device 5 according to the time before the obtainment of the lock. Consequently, a decrease in performance of the information processing system SYS1 is suppressed when either the arithmetic processing device 3 or the communicating device 5 exclusively processes a request. In addition, because the arithmetic processing device 3 and the communicating device 5 exclusively process a request after the obtainment of the lock, the consistency of processed data is ensured.

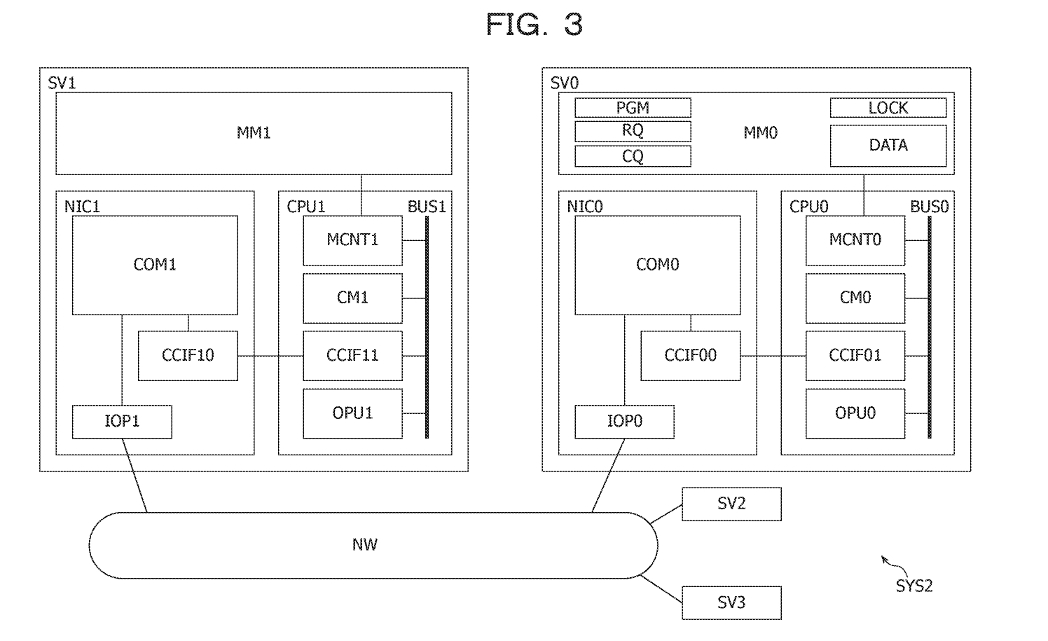

FIG. 3 illustrates another embodiment. The information processing system SYS2 illustrated in FIG. 3 includes servers SV (SV0 and SV1) coupled to each other via a network NW. Incidentally, other servers SV2 and SV3 may be coupled to the network NW.

The server SV0 is a processing node that performs data processing or the like on the basis of a request from the server SV1 and which transmits a result of the data processing or the like as a response to the server SV1. The server SV1 is a client node that transmits the request to the server SV0 via the network NW and which receives the response to the request from the server SV0. That is, the information processing system SYS2 operates as a distributed processing system having a function of processing a request by an RPC. The server SV0 is an example of a receiving side information processing device. The server SV1 is an example of a transmitting side information processing device. In the following description, the server SV0 will be referred to also as a processing node SV0, and the server SV1 will be referred to also as a client node SV1.

The server SV0 includes a processor such as a CPU0 that executes a program PGM for processing a request received from the server SV1. The server SV0 also includes an NIC0 and a main memory MM0 coupled to the CPU0. The CPU0 is an example of an arithmetic processing device. The main memory MM0 is an example of a main storage device. The NIC0 is an example of a communicating device.

The CPU0 includes an arithmetic unit OPU0 (CPU core), a cache coherent interface CCIF01, a cache memory CM0, and a memory controller MCNT0 coupled to each other via a bus BUS0. The arithmetic unit OPU0 performs arithmetic processing using data stored in the cache memory CM0 by executing the program PGM transferred from the main memory MM0 to the cache memory CM0. In addition, the arithmetic unit OPU0 processes a request handed over from the NIC0 by executing the program PGM. The cache coherent interface CCIF01 is coupled to the cache memory CM0 via the bus BUS0, and is coupled to a cache coherent interface CCIF00 of the NIC0.

The cache coherent interface CCIF01 is a memory interface for making access (for example kernel bypass transfer) from the NIC0 to the cache memory CM0. Therefore, access from the NIC0 to the cache memory CM0 via the cache coherent interface CCIF01 is made with similar performance to the performance of access from the arithmetic unit OPU0 to the cache memory CM0. The cache coherent interface CCIF01 enables direct access from the NIC0 to the cache memory CM0. Thus, high-speed access to data or the like is realized as compared with a case where the access is made via the CPU0. In addition, coherency between data retained in the cache memory CM0 and data retained in the main memory MM0 is maintained by making access from the NIC0 to the cache memory CM0 via the cache coherent interface CCIF01.

The cache memory CM0 retains part of data and instruction codes used by the arithmetic unit OPU0 among data and instruction codes stored in the main memory MM0. In addition, the cache memory CM0 retains at least part of a lock variable LOCK, the contents of a request queue RQ, and the contents of a completion queue CQ, the lock variable LOCK, the request queue RQ, and the completion queue CQ being stored in the main memory MM0. Incidentally, data or the like to be accessed for readout by the arithmetic unit OPU0 or the NIC0 may not be present within the cache memory CM0 (such a case will hereinafter be referred to as a cache miss). When a cache miss occurs, the cache memory CM0 reads out the data or the like from the main memory MM0, stores the data or the like in a storage area, and then outputs the data or the like to the arithmetic unit OPU0 or the NIC0.

The memory controller MCNT0 reads out data or the like from the main memory MM0 and outputs the data or the like to the cache memory CM0 on the basis of a readout access request output from the cache memory CM0. In addition, the memory controller MCNT0 writes data or the like transferred from the cache memory CM0 to the main memory MM0 on the basis of a writing access request output from the cache memory CM0.

The NIC0 includes a communication processing unit COM0, the cache coherent interface CCIF00, and an input-output port IOP0. The communication processing unit COM0 transmits a request received from the input-output port IOP0 to the CPU0 via the cache coherent interfaces CCIF00 and CCIF01. In addition, the communication processing unit COM0 outputs a response to the request, which response is received from the CPU0 via the cache coherent interfaces CCIF00 and CCIF01, to the input-output port IOP0. The cache coherent interface CCIF00 has functions similar to the functions of the cache coherent interface CCIF01, and enables access to the cache memory CM0 by the NIC0. The cache coherent interfaces CCIF00 and CCIF01 are an example of a cache interface.

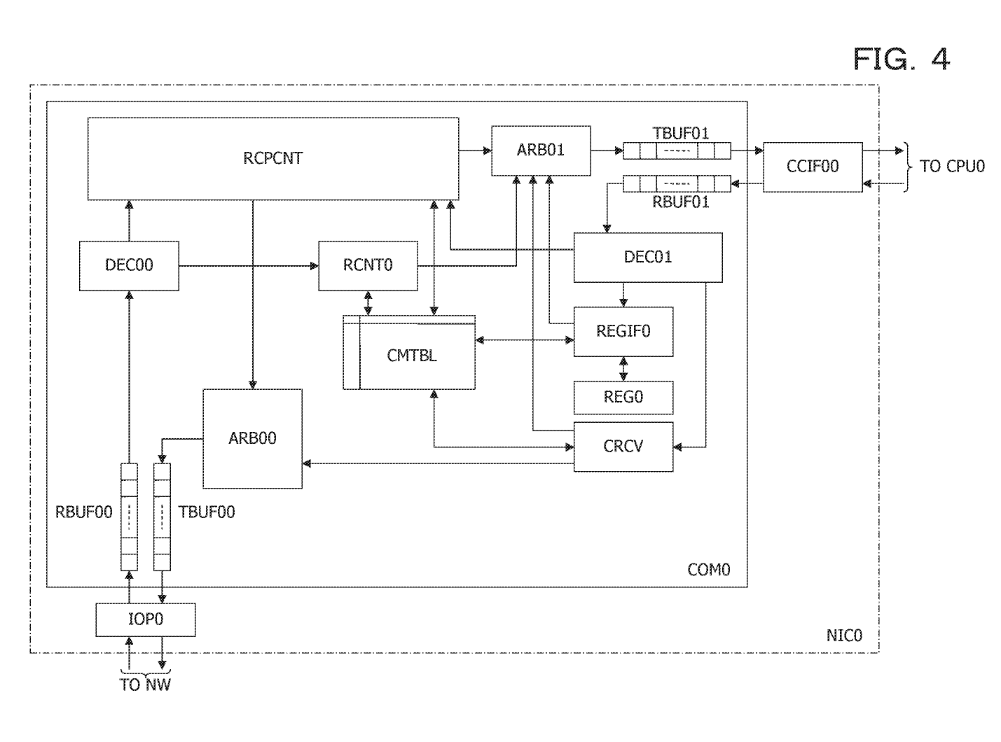

The input-output port IOP0 outputs the request received via the network NW to the communication processing unit COM0, and outputs the response to the request, which response is output from the communication processing unit COM0, to the network NW. An example of the NIC0 is illustrated in FIG. 4.

An area storing the program PGM executed by the CPU0 as well as the request queue RQ and the completion queue CQ are assigned to given addresses in the main memory MM0. In addition, a data area DATA storing data processed on the basis of a request from the server SV1 or the like and an area storing the lock variable LOCK are assigned to given addresses in the main memory MM0. As with the lock variable LOCK illustrated in FIG. 1, the lock variable LOCK is used for the CPU0 or the NIC0 to process a request exclusively.

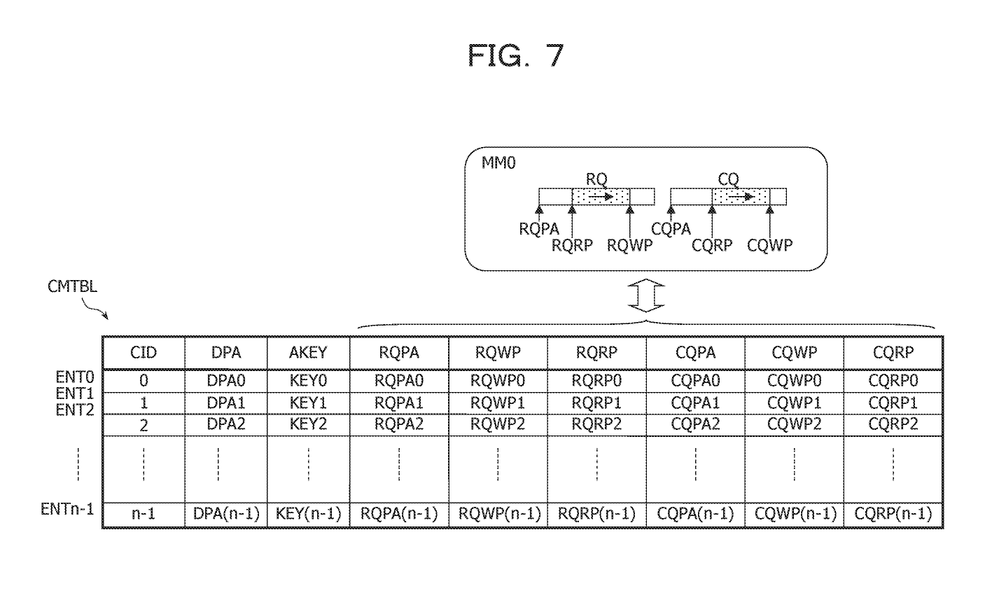

In the request queue RQ, requests from the server SV1 are written by the NIC0. The requests retained by the request queue RQ are extracted by the CPU0, and are processed by the CPU0. In the completion queue CQ, responses to the requests are written by the CPU0. The responses to the requests which responses are retained by the completion queue CQ are extracted by the NIC0. An example of the request queue RQ and the completion queue CQ is illustrated in FIG. 7.

As described above, the cache memory CM0 also retains at least part of the program PGM, the data within the data area DATA, the lock variable LOCK, the contents of the request queue RQ, and the contents of the completion queue CQ within the main memory MM0. The CPU0 and the NIC0 access the cache memory CM0 rather than the main memory MM0. The main memory MM0 is accessed by the cache memory CM0.

As with the server SV0, the server SV1 includes a CPU1 as well as an NIC1 and a main memory MM1 coupled to the CPU1. The CPU1 generates a request to be transmitted to the server SV0 and processes a response to the request which response is received from the server SV0 by executing a program in the main memory MM1 (cache memory CM1). The CPU1 has a similar configuration to the configuration of the CPU0 of the server SV0 except that the program executed by the CPU1 is different. That is, the CPU1 includes an arithmetic unit OPU1 (CPU core), a cache coherent interface CCIF11, the cache memory CM1, and a memory controller MCNT1 coupled to each other via a bus BUS1. The cache coherent interface CCIF11 has functions similar to the functions of the cache coherent interface CCIF01.

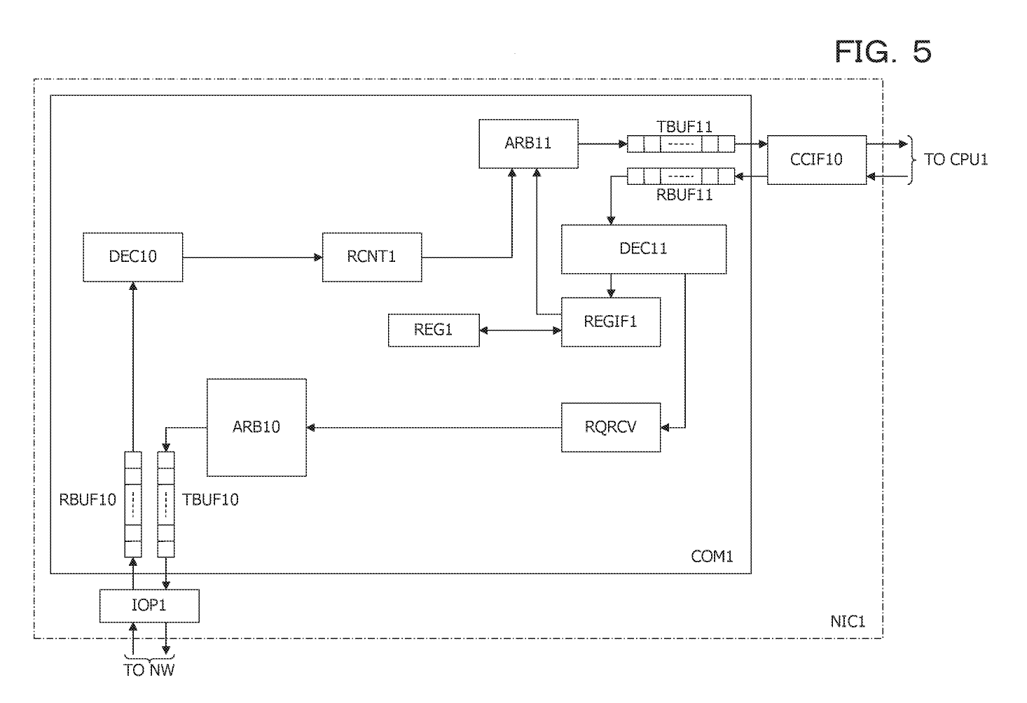

The NIC1 includes a communication processing unit COM1, a cache coherent interface CCIF10, and an input-output port IOP1. The NIC1 has a similar configuration to the configuration of the NIC0 except that the functions of the communication processing unit COM1 are different from the functions of the communication processing unit COM0. An example of the NIC1 is illustrated in FIG. 5.

The communication processing unit COM1 outputs, to the input-output port IOP1, a request received from the CPU1 via the cache coherent interfaces CCIF10 and CCIF11. The cache coherent interface CCIF10 has functions similar to the functions of the cache coherent interface CCIF00. The communication processing unit COM1 also transmits a response to the request, which response is received from the input-output port IOP1, to the CPU1 via the cache coherent interfaces CCIF10 and CCIF11. The input-output port IOP1 outputs the request output from the communication processing unit COM1 to the server SV0 via the network NW, and outputs the response to the request, which response is received from the server SV0 via the network NW, to the communication processing unit COM1.

FIG. 4 illustrates an example of an NIC in a processing node. The NIC and the processing node described with reference to FIG. 4 may be the NIC0 and the processing node SV0 illustrated in FIG. 3, respectively. The communication processing unit COM0 of the NIC0 includes a reception buffer RBUF00, a decoder unit DEC00, a remote procedure processing unit RCPCNT, a request processing unit RCNT0, an arbitrating unit ARB01, a transmission buffer TBUF01, and a connection management table CMTBL. The communication processing unit COM0 also includes a reception buffer RBUF01, a decoder unit DEC01, a register interface REGIF0, a register REG0, a response receiving unit CRCV, an arbitrating unit ARB00, and a transmission buffer TBUF00. The connection management table CMTBL is assigned to an input/output (I/O) space accessible by the CPU0. An example of the connection management table CMTBL is illustrated in FIG. 7.

The reception buffer RBUF00 is an example of a receiving unit that receives requests from the client node SV1. The reception buffer RBUF00 includes a plurality of retaining units that sequentially retain the requests received from the input-output port IOP0. The decoder unit DEC00 sequentially extracts the requests retained in the reception buffer RBUF00, and decodes the extracted requests. When a request is a request of an RPC, the decoder unit DEC00 outputs the request to the remote procedure processing unit RCPCNT. When a request is a request of other than an RPC, the decoder unit DEC00 outputs the request to the request processing unit RCNT0. A request of an RPC is an example of a first request. A request of other than an RPC is an example of a second request. Because the decoder unit DEC00 is provided with a function of distinguishing kinds of requests and allocating the requests on the basis of results of the distinction, the remote procedure processing unit RCPCNT and the request processing unit RCNT0 process the respective kinds of requests. The decoder unit DEC00 is an example of a request distinguishing unit that distinguishes requests from the client node SV1.

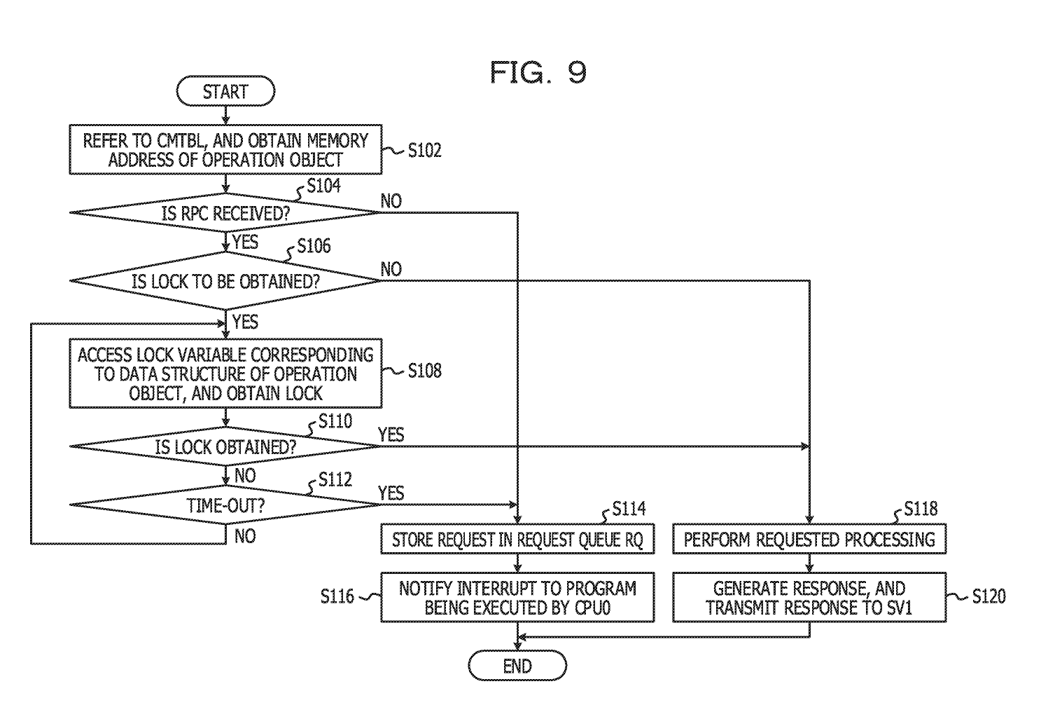

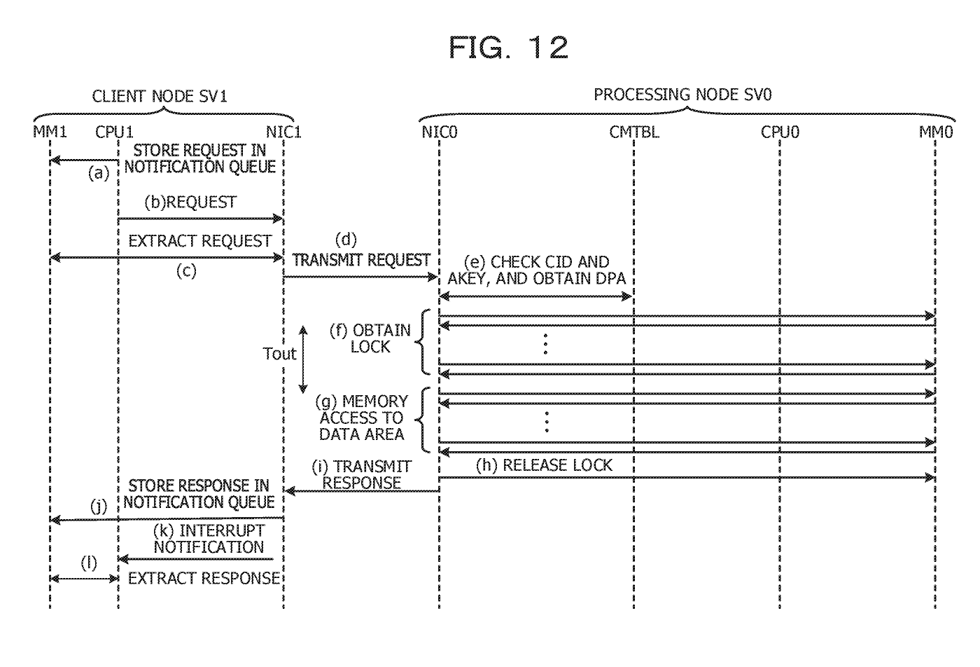

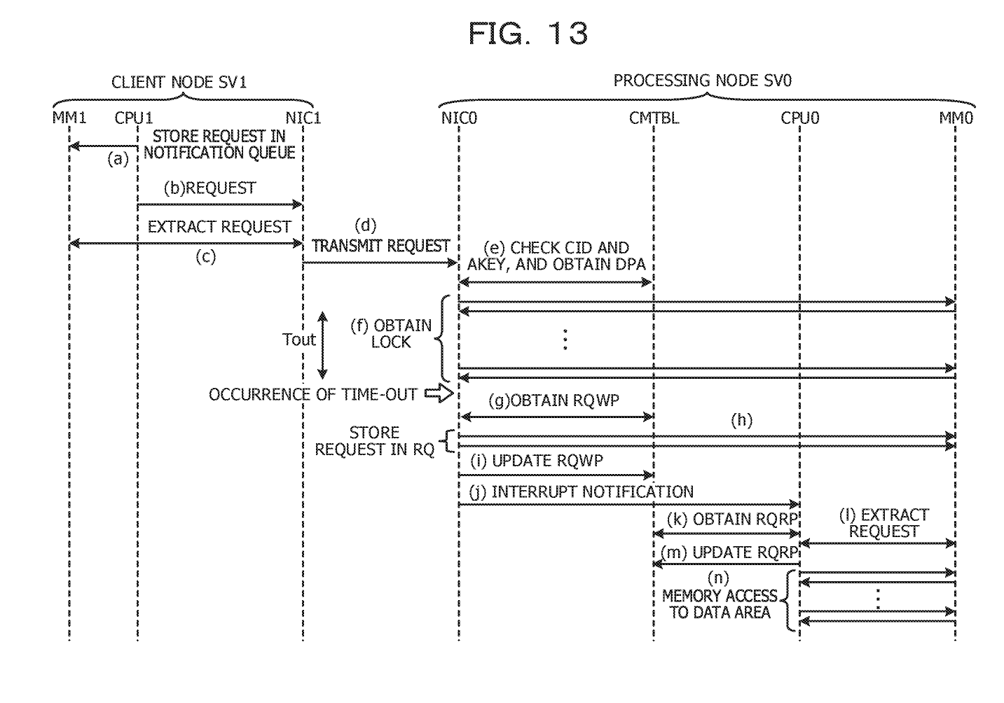

When the remote procedure processing unit RCPCNT receives a request from the decoder DEC00, the remote procedure processing unit RCPCNT accesses the connection management table CMTBL, and determines the validity of the request. When the request is valid, and the remote procedure processing unit RCPCNT is to perform exclusive processing, the remote procedure processing unit RCPCNT performs an operation of obtaining a lock. When the lock can be obtained, the remote procedure processing unit RCPCNT outputs, to the arbitrating unit ARB01, a packet of a memory access request or the like for the remote procedure processing unit RCPCNT itself to process the request. An example of the operation of obtaining the lock will be described with reference to FIG. 9, FIG. 12, and FIG. 13.

When the remote procedure processing unit RCPCNT itself processes the request, a processing time is shortened as compared with a case where the CPU0 is made to process the request by interrupt processing. When the remote procedure processing unit RCPCNT does not obtain the lock within the given time, on the other hand, the remote procedure processing unit RCPCNT outputs a packet (interrupt notification) for making the CPU0 process the request to the arbitrating unit ARB01 in order to avoid lengthening a time before a start of processing of the request. Incidentally, in the operation of obtaining the lock, the remote procedure processing unit RCPCNT generates a packet for reading out the value of the lock variable LOCK illustrated in FIG. 3 or a packet for rewriting the lock variable LOCK, and outputs the generated packet to the arbitrating unit ARB01.

In addition, when the request is valid, and the remote procedure processing unit RCPCNT is not to perform exclusive processing, the remote procedure processing unit RCPCNT outputs a packet of a memory access request or the like for the remote procedure processing unit RCPCNT itself to process the request to the arbitrating unit ARB01 without performing the lock obtaining operation. For example, writing processing performed on the basis of a request is exclusive processing involving a change in data, and therefore the lock is obtained before the writing processing. On the other hand, reading processing performed on the basis of a request does not involve a change in data and is thus not exclusive processing, so that the lock is not obtained. A request for which exclusive processing is not performed is an example of a third request processed by the remote procedure processing unit RCPCNT without referring to the lock variable LOCK.

When the remote procedure processing unit RCPCNT receives a response to an RPC request from the decoder unit DEC01, the remote procedure processing unit RCPCNT outputs the received response to the arbitrating unit ARB00 to transmit the response to the client node SV1. Incidentally, the remote procedure processing unit RCPCNT may be implemented by hardware, or may be implemented by a remote procedure processing program (software) that performs the functions of the remote procedure processing unit RCPCNT. When the remote procedure processing unit RCPCNT is implemented by software, the remote procedure processing unit RCPCNT includes a processor such as a CPU that executes the remote procedure processing program. The remote procedure processing unit RCPCNT is an example of a first request processing unit.

When the request processing unit RCNT0 receives a request of other than an RPC from the decoder unit DEC00, the request processing unit RCNT0 generates a packet for storing the request in the request queue RQ illustrated in FIG. 3, and outputs the generated packet to the arbitrating unit ARB01. The request processing unit RCNT0 refers to the connection management table CMTBL to detect a position of the request queue RQ in which position to store the request. After storing the request in the request queue RQ, the request processing unit RCNT0 outputs a packet (interrupt notification) for making the CPU0 process the request to the arbitrating unit ARB01. The request processing unit RCNT0 is an example of a second request processing unit. Performing processing by the remote procedure processing unit RCPCNT or the request processing unit RCNT0 according to kinds of requests (RPCs or other than RPCs) facilitates control of the requests as compared with a case where the requests are processed by one processing unit. As a result, circuits that process requests are designed easily, and a possibility of a defect or the like occurring in the circuits is decreased.

The arbitrating unit ARB01 sequentially selects, by arbitration, packets from the remote procedure processing unit RCPCNT, the request processing unit RCNT0, the register interface REGIF0, and the response receiving unit CRCV, and outputs the selected packets to the transmission buffer TBUF01. The transmission buffer TBUF01 includes a plurality of retaining units that sequentially retain the packets received from the arbitrating unit ARB01. The transmission buffer TBUF01 sequentially outputs the retained packets to the CPU0 via the cache coherent interface CCIF00. The reception buffer RBUF01 includes a plurality of retaining units that sequentially retain packets received from the CPU0 via the cache coherent interface CCIF00.

The decoder unit DEC01 sequentially extracts the packets retained in the reception buffer RBUF01, and decodes the extracted packets. When a packet is related to an RPC processed by the remote procedure processing unit RCPCNT (response, lock obtaining processing, or the like), the decoder unit DEC01 outputs the packet to the remote procedure processing unit RCPCNT. When a packet includes a response to a request from the request processing unit RCNT0 or a response to an RPC request handed over from the remote procedure processing unit RCPCNT to the CPU0, the decoder unit DEC01 outputs the packet to the response receiving unit CRCV. In addition, when a packet includes a request to access the connection management table CMTBL or the register REG0, the decoder unit DEC01 outputs the packet to the register interface REGIF0. The decoder unit DEC01 is provided with a function of distinguishing kinds of responses to requests and allocating the responses on the basis of results of the distinction. Thus, response processing can be performed in each of the remote procedure processing unit RCPCNT and the response receiving unit CRCV. In addition, a response to an RPC request handed over from the remote procedure processing unit RCPCNT to the CPU0 can be output to the response receiving unit CRCV. As a result, responses to RPC requests from the CPU0 can be processed by only the response receiving unit CRCV, so that control is made easier than in a case where the responses are distributed to and processed by the remote procedure processing unit RCPCNT and the response receiving unit CRCV. The decoder unit DEC01 is an example of a response distinguishing unit that distinguishes responses from the CPU0.

The register interface REGIF0 accesses the connection management table CMTBL or the register REG0 on the basis of a packet from the CPU0 which packet is decoded by the decoder unit DEC01, and generates a response packet on the basis of a result of the access. Then, the register interface REGIF0 outputs the generated response packet to the CPU0 via the arbitrating unit ARB01. Incidentally, the connection management table CMTBL and the register REG0 are assigned to an I/O space accessible by the CPU0.

When the response receiving unit CRCV receives a packet including a response (completion notification) to a request processed by the CPU0 from the decoder unit DEC01, the response receiving unit CRCV generates a packet for extracting the response to the request which response is stored in the completion queue CQ. The response receiving unit CRCV then outputs the generated packet to the arbitrating unit ARB01. The response receiving unit CRCV refers to the connection management table CMTBL to detect a position from which to extract the response in the completion queue CQ. When the response receiving unit CRCV receives a packet including the response (data or the like) extracted from the completion queue CQ from the decoder unit DEC01, the response receiving unit CRCV outputs the received response to the arbitrating unit ARB00.

The arbitrating unit ARB00 sequentially selects, by arbitration, responses from the remote procedure processing unit RCPCNT and the response receiving unit CRCV, and outputs the selected responses to the transmission buffer TBUF00. The transmission buffer TBUF00 includes a plurality of retaining units that sequentially retain the responses received from the arbitrating unit ARB00. The transmission buffer TBUF00 sequentially outputs the retained responses to the server SV1 or the like as a requesting source via the input-output port IOP0 and the network NW.

FIG. 5 illustrates an example of an NIC in a client node. The NIC and the client node described with reference to FIG. 5 may be the NIC1 and the client node SV1 illustrated in FIG. 3, respectively. As with the communication processing unit COM0, the communication processing unit COM1 of the NIC1 includes reception buffers RBUF10 and RBUF11, transmission buffers TBUF10 and TBUF11, decoder units DEC10 and DEC11, arbitrating units ARB10 and ARB11, and a response processing unit CCNT1. In addition, the communication processing unit COM1 includes a register interface REGIF1 and a register REG1 as with the communication processing unit COM0, and further includes a request receiving unit RQRCV. In the communication processing unit COM1, elements similar to the elements of the communication processing unit COM0 are identified by the same reference symbols as the elements of the communication processing unit COM0 except for one-digit or two-digit numbers at ends of the reference symbols.

The respective functions of the reception buffers RBUF10 and RBUF11 and the transmission buffers TBUF10 and TBUF11 are similar to the respective functions of the reception buffers RBUF00 and RBUF01 and the transmission buffers TBUF00 and TBUF01 illustrated in FIG. 4. The register interface REGIF1 has a function similar to the function of the register interface REGIF0 illustrated in FIG. 4 in that the register interface REGIF1 accesses the register REG1.

The decoder unit DEC11 sequentially extracts packets including requests from the CPU1 which packets are retained in the reception buffer RBUF11, and decodes the extracted packets. When a packet includes a request to the processing node SV0, the decoder unit DEC11 outputs the packet to the request receiving unit RQRCV. When a packet includes a request to access the register REG1, the decoder unit DEC11 outputs the packet to the register interface REGIF1.

The request receiving unit RQRCV outputs the request included in the packet from the decoder unit DEC11 to the arbitrating unit ARB10. The arbitrating unit ARB10 outputs the request from the request receiving unit RQRCV to the transmission buffer TBUF10. Incidentally, the arbitrating unit ARB10 may sequentially select, by arbitration, the request from the request receiving unit RQRCV and a request received from another element not illustrated in FIG. 5.

The decoder unit DEC10 sequentially extracts responses from the processing node SV0 which responses are retained in the reception buffer RBUF10, decodes the extracted responses, and outputs the decoded responses to the response processing unit CCNT1. The response processing unit CCNT1 generates packets on the basis of the responses from the decoder unit DEC10, and outputs the generated packets to the arbitrating unit ARB11.

The arbitrating unit ARB11 sequentially selects, by arbitration, packets from the response processing unit CCNT1 and the register interface REGIF1, and outputs the selected packets to the CPU1 via the transmission buffer TBUF11.

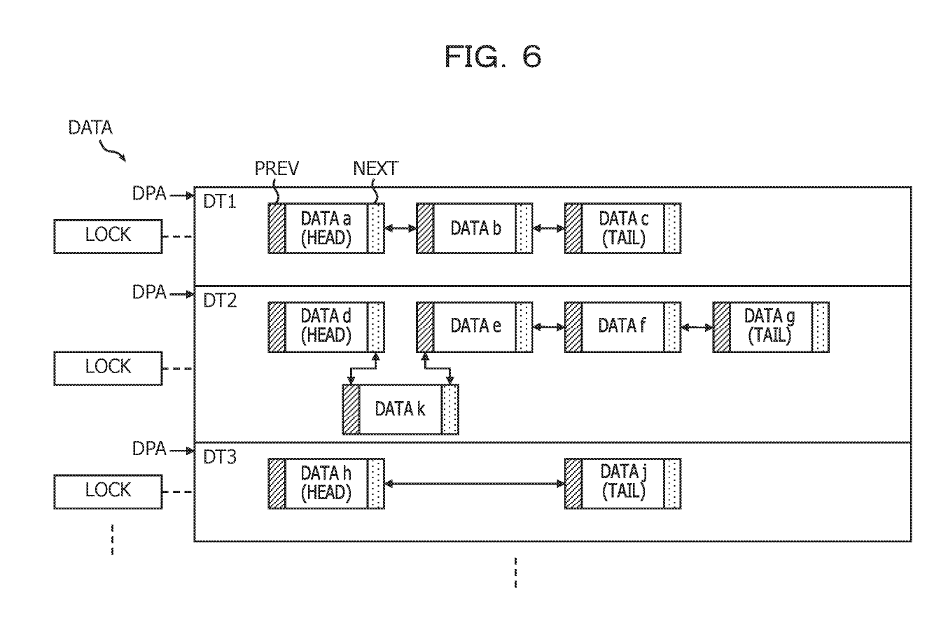

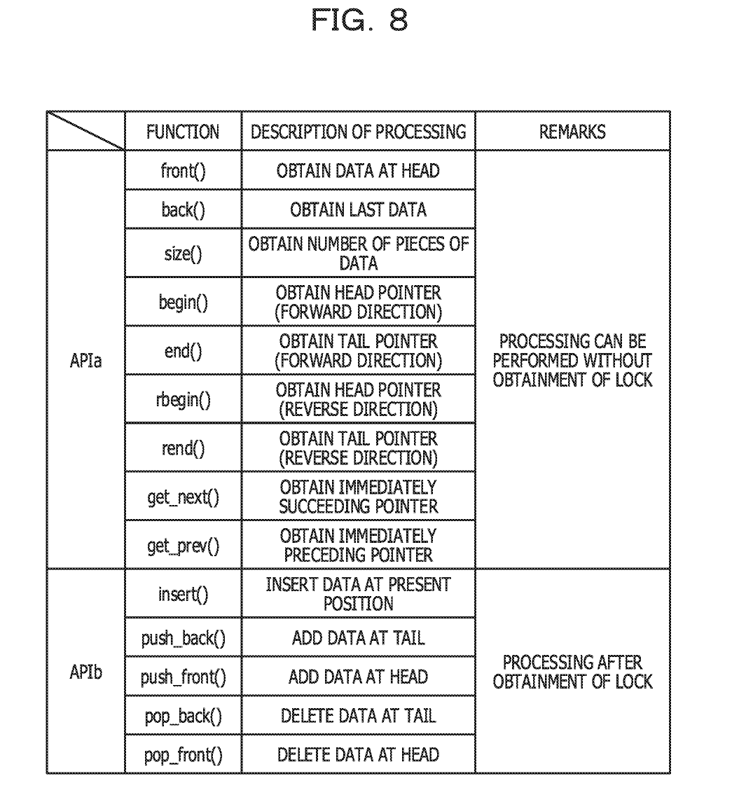

FIG. 6 illustrates an example of a data structure of data stored in a data area accessed on the basis of an RPC request. The data area described with reference to FIG. 6 may be the data area DATA illustrated in FIG. 3. FIG. 6 illustrates a state in which data is added or inserted by using a function (push_back( ), push_front( ), insert( ), or the like) illustrated in FIG. 8. A plurality of data areas DT (DT1, DT2, DT3, . . . ) are allocated to the data area DATA. The CPU0 executes a data processing program that processes data for each data area DT (each data structure), or executes the data processing program for each group of a given number of data areas DT.

A given number of pieces of data (a, b, and c or the like) as objects for RPCs, the given number of pieces of data being stored in each data area DT, are sequentially coupled to each other by pointers prev referring to immediately preceding coupled data and pointers next referring to immediately succeeding coupled data. Then, the data structure of a bidirectional coupled list supported by a standard C++ library (std::list) or the like is constructed in each data area DT.

A head physical address DPA of each data area DT is registered in the connection management table CMTBL illustrated in FIG. 7. In addition, a lock variable LOCK is provided so as to correspond to each of the data areas DT. Each data area DT adapts to access by multiple threads because each data area DT is exclusively accessed on the basis of the lock variable LOCK. That is, each data area DT illustrated in FIG. 6 has a thread-safe data structure.

FIG. 7 illustrates an example of a connection management table. The connection management table illustrated in FIG. 7 may be the connection management table CMTBL illustrated in FIG. 4. The connection management table CMTBL includes n entries ENT (ENT0 to ENTn−1; n is an integer of two or more) each including a region storing a connection number CID, the head physical address DPA of a data area DT illustrated in FIG. 6, and an access key AKEY. Each entry ENT includes a region storing a head physical address RQPA of the request queue RQ, a write pointer RQWP of the request queue RQ, and a read pointer RQRP of the request queue RQ. In addition, each entry ENT includes a region storing a head physical address CQPA of the completion queue CQ, a write pointer CQWP of the completion queue CQ, and a read pointer CQRP of the completion queue CQ. The head physical address RQPA, the write pointer RQWP, and the read pointer RQRP are an example of request information. The head physical address CQPA, the write pointer CQWP, and the read pointer CQRP are an example of response information.

The connection number CID is a unique identification (ID) assigned to each data area DT (data structure). A request to access the data area DT includes the connection number CID. The head physical address DPA is used to specify the data area DT (FIG. 6) in which to perform data processing in RPC processing. The access key AKEY is a unique code (KEY0, KEY1, or the like) assigned to each data area DT. The access key AKEY is used to determine the presence or absence of a right to access the data area DT. A request to access the data area DT includes the access key AKEY. The connection number CID and the access key AKEY of each data area DT are notified from the processing node SV0 to the client node SV1 before the client node SV1 issues a request (for example at a time of a start of the information processing system SYS2).

The write pointer RQWP of the request queue RQ indicates a position in which a newest request among requests stored in the request queue RQ is stored. The communication processing unit COM0 of the NIC0 stores a new request in a region next to the position indicated by the write pointer RQWP, and updates the write pointer RQWP. The read pointer RQRP of the request queue RQ indicates a position in which an oldest request among the requests stored in the request queue RQ is stored. The CPU0 extracts the request from the position indicated by the read pointer RQRP, processes the request, and updates the read pointer RQRP.

The write pointer CQWP of the completion queue CQ indicates a position in which a newest response among responses stored in the completion queue CQ is stored. The CPU0 stores a new response in a region next to the position indicated by the write pointer CQWP, and updates the write pointer CQWP. The read pointer CQRP of the completion queue CQ indicates a position in which an oldest response among the responses stored in the completion queue CQ is stored. The communication processing unit COM0 of the NIC0 extracts the response from the position indicated by the read pointer CQRP, and updates the read pointer CQRP.

The connection management table CMTBL can be accessed from both of the remote procedure processing unit RCPCNT and the request processing unit RCNT0, and can also be accessed from the CPU0. Therefore, the remote procedure processing unit RCPCNT and the request processing unit RCNT0 can hand over the processing of a request to the CPU0 using the request queue RQ, and can receive a response to the request from the CPU0 using the completion queue CQ.

FIG. 8 illustrates an example of functions used for RPCs. The functions (application programming interfaces (APIs)) illustrated in FIG. 8 are classified into a function group APIa processed without the lock being obtained and a function group APIb processed after the lock is obtained (exclusive processing). The functions of the function groups APIa and APIb are for example included in the standard C++ library (std::list). The function group APIa includes functions front( ), back( ), size( ), begin( ), end( ), rbegin( ), rend( ), get_next( ), and get_prev( ). The functions included in the function group APIa do not change the data structure constructed in the data area DT, and can therefore be processed without the lock being obtained.

The function get_next( ) is a function that takes an iterator (pointer) as an argument and which returns a next iterator. The function get_prev( ) is a function that takes an iterator as an argument and which returns an immediately preceding iterator. The functions get_next( ) and get_prev( ) are used to access data within the data area DT by an RPC.

On the other hand, the functions insert( ), push_back( ), push_front( ), pop_back( ), and pop_front( ) included in the function group APIb change the data structure constructed in the data area DT, and are therefore processed after the obtainment of the lock. Incidentally, the function groups APIa and APIb may each include other functions.

When a request received from the client node SV1 includes one of the functions of the function group APIa that can be processed without the obtainment of the lock, the NIC0 of the processing node SV0 operates the remote procedure processing unit RCPCNT to directly access the data structure illustrated in FIG. 6. When a request received from the client node SV1 includes one of the functions of the function group APIb to be processed after the obtainment of the lock, on the other hand, the NIC0 operates the remote procedure processing unit RCPCNT to directly access the data structure illustrated in FIG. 6 after the obtainment of the lock. However, when the lock is not obtained within the given time, the remote procedure processing unit RCPCNT makes the CPU0 process the remote procedure processing request received from the client node SV1.

FIG. 9 illustrates an example of operation in a case where an NIC of a processing node receives a packet from a client node. FIG. 9 illustrates a control method of an information processing system. The NIC, the processing node, the client node and the information processing system described with reference to FIG. 9 may be the NIC0, the processing node SV0, the client node SV1 and the information processing system SYS2 illustrated in FIG. 3, respectively.

First, in step S102, the remote procedure processing unit RCPCNT of the NIC0 refers to the connection management table CMTBL illustrated in FIG. 7 on the basis of a connection number CID included in the packet, and obtains the head physical address DPA of a data area DT as an operation object. Incidentally, when an access key AKEY included in the packet does not coincide with an access key AKEY stored in the connection management table CMTBL in correspondence with the data area DT as an operation object, the NIC0 determines that the packet is invalid, and then ends the operation.

Next, in step S104, the NIC0 determines whether or not the received packet represents an RPC request. When the received packet represents an RPC request, the NIC0 makes the operation proceed to step S106. When the received packet does not represent an RPC request, the NIC0 makes the operation proceed to step S114 to make the CPU0 process the packet. Detection of the contents of the packet (decoding operation) in step S104 is performed by the decoder unit DEC00.

In step S106, the NIC0 determines whether or not to obtain the lock on the basis of a result of decoding by the decoder unit DEC00. When the received packet includes one of the functions of the function group APIb illustrated in FIG. 8, the NIC0 makes the operation proceed to step S108 to obtain the lock. When the received packet includes one of the functions of the function group APIa illustrated in FIG. 8, processing can be performed without the obtainment of the lock, and therefore the NIC0 makes the operation proceed to step S118. The processing in step S106 is performed by the remote procedure processing unit RCPCNT.

In step S108, the NIC0 makes memory access to the lock variable LOCK corresponding to the data area DT as an operation object, and performs a lock obtaining operation. For example, the remote procedure processing unit RCPCNT transmits a packet for executing a Test and Set instruction to the CPU0 via the transmission buffer TBUF01, and determines whether or not the lock is obtained. Next, in step S110, the NIC0 makes the operation proceed to step S118 when the lock is obtained, or the NIC0 makes the operation proceed to step S112 when the lock is not obtained.

In step S112, when the given time has passed without the lock being obtained since a start of the lock obtaining operation, the NIC0 determines that a time-out has occurred, and makes the operation proceed to step S114. When the given time has not passed since the start of the lock obtaining operation, on the other hand, the NIC0 returns the operation to step S108 to perform the lock obtaining operation again. The processing in step S112 is performed by the remote procedure processing unit RCPCNT. For example, the remote procedure processing unit RCPCNT includes a timer for determining that a time-out has occurred, the timer being common to the plurality of data areas DT.

In step S114, the NIC0 obtains the head physical address RQPA and the write pointer RQWP of the request queue RQ (FIG. 7) from an entry in the connection management table CMTBL which entry corresponds to the connection number CID included in the packet. Then, the NIC0 stores the request included in the packet in an area indicated by the write pointer RQWP of the request queue RQ, and updates the write pointer RQWP. It is to be noted that the request stored in the request queue RQ by the NIC0 when a time-out has occurred in step S112 includes one (for example the function insert( )) of the functions of the function group APIb illustrated in FIG. 8.

Next, in step S116, the NIC0 notifies an interrupt to a program by which the CPU0 performs data processing on the data area DT as an operation object, and then ends the operation. The notification of the interrupt is performed by the remote procedure processing unit RCPCNT by transmitting a packet for making writing access to an interrupt register of the CPU0 or the like to the CPU0 via the arbitrating unit ARB01 and the transmission buffer TBUF01. On the basis of the notification of the interrupt from the NIC0, the CPU0 executes the data processing program corresponding to the data area DT as an operation object, and processes the request stored in the request queue RQ. That is, the processing of the request is handed over from the NIC0 to the CPU0.

Because the processing of the request is handed over to the CPU0, the NIC0 can start processing a next request. Thus, stalling of the remote procedure processing unit RCPCNT as a result of taking time to obtain the lock is suppressed. Because the remote procedure processing unit RCPCNT is not stalled, the decoder unit DEC00 can sequentially extract requests from the reception buffer RBUF00. As a result, an overflow of the reception buffer RBUF00 is suppressed, and a decrease in processing performance of the information processing system SYS2 is suppressed.

In step S118, the NIC0 processes the request included in the packet received from the client node SV1. For example, the remote procedure processing unit RCPCNT obtains the position (address) of data to be accessed in the data area DT on the basis of the head physical address DPA obtained in step S102. The remote procedure processing unit RCPCNT accesses the cache memory CM0 by outputting a packet for making memory access to the obtained position to the arbitrating unit ARB01. Then, the remote procedure processing unit RCPCNT processes the request by receiving a packet indicating a result of the memory access from the cache memory CM0. When the request can be processed without the obtainment of the lock, the remote procedure processing unit RCPCNT directly processes the request. Request processing efficiency is thereby improved as compared with a case where an interrupt is notified to the CPU0 to make the CPU0 process the request. In addition, the CPU0 can perform other processing. Thus, the processing performance of the CPU0 is improved as compared with a case where the CPU0 is made to process the request.

Next, in step S120, the NIC0 generates a packet including a response indicating a result of the processing in step S118, and transmits the generated packet to the client node SV1 as the requesting source of the request. The NIC0 then ends the operation. The operation in step S120 is performed by the remote procedure processing unit RCPCNT, the arbitrating unit ARB00, and the transmission buffer TBUF00.

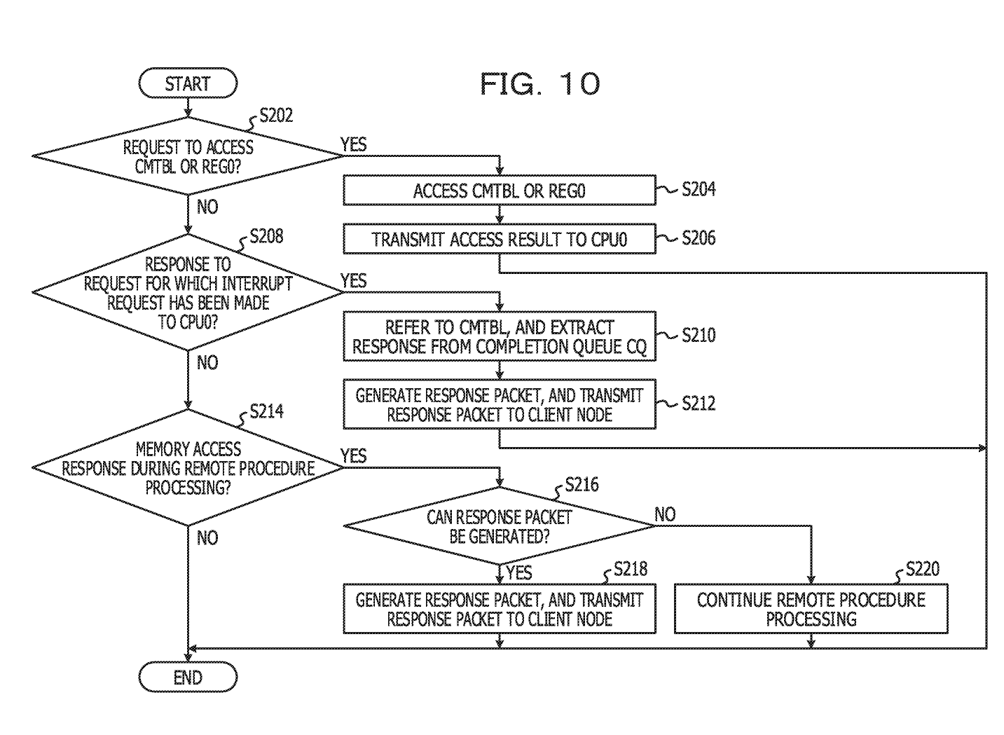

FIG. 10 illustrates an example of operation in a case where an NIC of a processing node receives a packet from a CPU. FIG. 10 illustrates a control method of an information processing system. The NIC, the processing node, the CPU and the information processing system described with reference to FIG. 10 may be the NIC0, the processing node SV0, the CPU0 and the information processing system SYS2 illustrated in FIG. 3, respectively.

First, in step S202, when the received packet indicates a request to access the connection management table CMTBL or the register REG0, the NIC0 makes the operation proceed to step S204. When the received packet does not indicate a request to access the connection management table CMTBL or the register REG0, the NIC0 makes the operation proceed to step S208. The processing in step S202 is performed by the decoder unit DEC01.

In step S204, the NIC0 makes read access or write access to the connection management table CMTBL or the register REG0. The NIC0 then makes the operation proceed to step S206. The processing in step S204 is performed by the register interface REGIF0.

In step S206, the NIC0 generates a packet for transmitting a result of the access to the connection management table CMTBL or the register REG0 to the CPU0, and transmits the generated packet to the CPU0. The NIC0 then ends the operation. The processing in step S206 is performed by the register interface REGIF0, the arbitrating unit ARB01, and the transmission buffer TBUF01.

In step S208, when the received packet indicates a response to a request that the CPU0 is made to process by an interrupt request to the CPU0, the NIC0 makes the operation proceed to step S210. When the received packet does not indicate a response to a request that the CPU0 is made to process by an interrupt request to the CPU0, the NIC0 makes the operation proceed to step S214. The processing in step S208 is performed by the decoder unit DEC01.

In step S210, the NIC0 refers to the connection management table CMTBL, and obtains the head physical address CQPA and the read pointer CQRP of the completion queue CQ. The NIC0 transmits, to the CPU0, a packet for making memory access to the completion queue CQ on the basis of the obtained head physical address CQPA and the obtained read pointer CQRP. The NIC0 then extracts the response to the request processed by the CPU0 from the completion queue CQ. The processing in step S210 is performed by the response receiving unit CRCV, the arbitrating unit ARB01, and the transmission buffer TBUF01.

Next, in step S212, the NIC0 generates a packet including the response extracted from the completion queue CQ in step S210, and transmits the generated packet to the client node SV1. The NIC0 then ends the operation. The processing in step S212 is performed by the response receiving unit CRCV, the arbitrating unit ARB00, and the transmission buffer TBUF00.

In step S214, when the received packet indicates a response in relation to memory access for processing an RPC request in the remote procedure processing unit RCPCNT, the NIC0 makes the operation proceed to step S216. The memory access for processing the RPC request (memory access during remote procedure processing) is for example memory access for a lock obtaining operation, memory access to the data area DT, or the like. When the received packet is other than a response in relation to the processing of the RPC request which processing is being performed in the remote procedure processing unit RCPCNT, the NIC0 ends the operation. The processing in step S214 is performed by the decoder unit DEC01.

In step S216, the NIC0 makes the operation proceed to step S218 when a response to the RPC request can be generated, and the NIC0 makes the operation proceed to step S220 when not in a state of generating a response to the RPC request. The processing in step S216 is performed by the remote procedure processing unit RCPCNT. In step S218, the NIC0 generates a packet including the response to the RPC request, and transmits the generated packet to the client node SV1. The processing in step S218 is performed by the remote procedure processing unit RCPCNT, the arbitrating unit ARB00, and the transmission buffer TBUF00.

In step S220, the NIC0 continues the remote procedure processing such as memory access for processing the RPC request. The NIC0 then ends the operation. That is, when the received packet indicates a response in relation to memory access for processing the RPC request in the remote procedure processing unit RCPCNT, the operations in steps S214, S216, and S220 are repeated. The processing in step S220 is performed by the remote procedure processing unit RCPCNT, the arbitrating unit ARB01 and the transmission buffer TBUF01, and the reception buffer RBUF01 and the decoder unit DEC01.

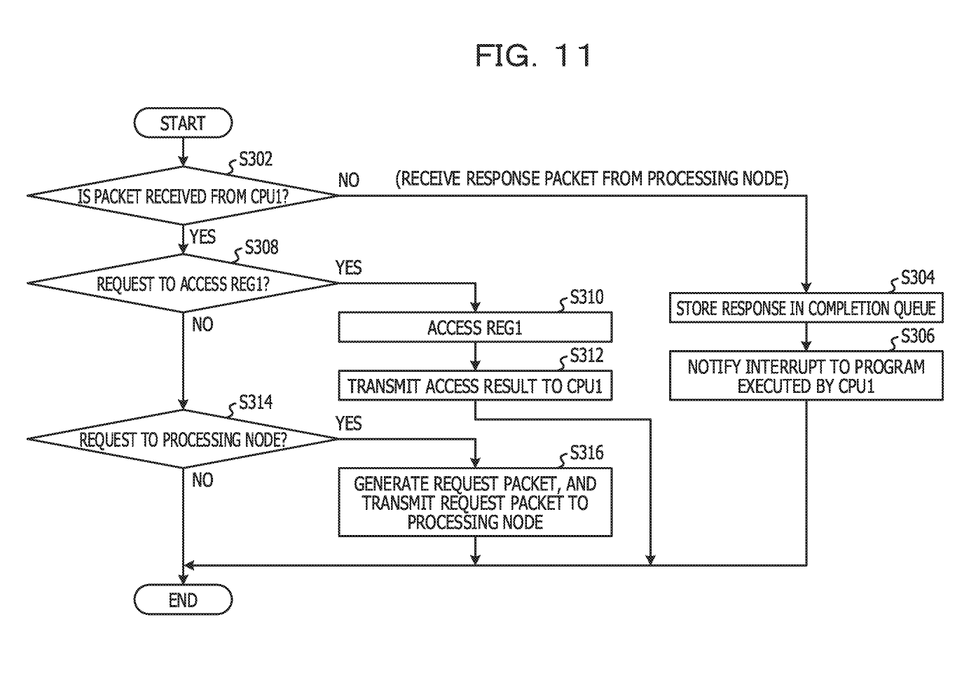

FIG. 11 illustrates an example of operation in a case where an NIC of a client node receives a packet. FIG. 11 illustrates a control method of an information processing system. The NIC, the client node and the information processing system described with reference to FIG. 11 may be the NIC1, the client node SV1 and the information processing system SYS2 illustrated in FIG. 3, respectively.

First, in step S302, the NIC1 makes the operation proceed to step S308 when receiving a packet from the CPU1, or the NIC1 makes the operation proceed to step S304 when receiving a response packet from the processing node SV0. The processing in step S302 is performed by the decoder units DEC11 and DEC10.

In step S304, the NIC1 generates a packet for storing a response included in the response packet from the processing node SV0 in a completion queue assigned to the main memory MM1, and outputs the generated packet to the CPU1. The processing in step S304 is performed by the response processing unit CCNT1, the arbitrating unit ARB11, and the transmission buffer TBUF11.

After the response is stored in the completion queue, the NIC1 in step S306 notifies an interrupt to a program executed by the CPU1. The NIC1 then ends the operation. The notification of the interrupt is performed by transmitting, to the CPU1, a packet for making writing access to an interrupt register of the CPU1 or the like. The processing in step S306 is performed by the response processing unit CCNT1, the arbitrating unit ARB11, and the transmission buffer TBUF11.

When the received packet indicates a request to access the register REG1 in step S308, on the other hand, the NIC1 makes the operation proceed to step S310. When the received packet does not indicate a request to access the register REG1, the NIC1 makes the operation proceed to step S314. The processing in step S308 is performed by the decoder unit DEC11.

In step S310, the NIC1 makes read access or write access to the register REG1. The processing in step S308 is performed by the register interface REGIF1. Next, in step S312, the NIC1 generates a packet including a result of the access to the register REG1, and transmits the generated packet to the CPU1. The NIC1 then ends the operation. The packet is for example a packet for storing information in the completion queue assigned to the main memory MM1. The processing in step S312 is performed by the register interface REGIF1, the arbitrating unit ARB11, and the transmission buffer TBUF11.

In step S314, when the received packet indicates a request of an RPC or the like to the processing node SV0, the NIC1 makes the operation proceed to step S316. When the received packet does not indicate a request of an RPC or the like to the processing node SV0, the NIC1 ends the operation. The processing in step S314 is performed by the decoder unit DEC11.

In step S316, the NIC1 generates a packet including the request received from the CPU1, and transmits the generated packet to the processing node SV0. The NIC1 then ends the operation. The processing in step S316 is performed by the request receiving unit RQRCV, the arbitrating unit ARB10, and the transmission buffer TBUF10.

FIG. 12 illustrates an example of operation of an information processing system. FIG. 12 illustrates a control method of the information processing system. The information processing system described with reference to FIG. 12 may be the information processing system SYS2 illustrated in FIG. 3. FIG. 12 illustrates an example in which an RPC request to be processed after the obtainment of the lock is issued from the client node SV1 to the processing node SV0, and the NIC0 obtains the lock and performs remote procedure processing without using the program of the CPU0. The RPC request includes for example the function insert( ), push_back( ), or the like.

First, in the client node SV1, the CPU1 stores a request in a notification queue assigned to the main memory MM1, and transmits a packet of the request to the NIC1 ((a) and (b) in FIG. 12). On the basis of the packet from the CPU1, the NIC1 accesses the notification queue, and extracts the RPC request. The NIC1 generates a packet including the extracted request, and transmits the generated packet to the processing node SV0 ((c) and (d) in FIG. 12).

On the basis of the packet from the client node SV1, the NIC0 of the processing node SV0 refers to the connection management table CMTBL, and checks a connection number CID and an access key AKEY included in the packet. In addition, the NIC0 refers to the connection management table CMTBL, and obtains the head physical address DPA of the data area DT as an operation object ((e) in FIG. 12).

Next, because the request from the client node SV1 is a function to be processed after the obtainment of the lock, the NIC0 performs an operation of obtaining the lock by using the lock variable LOCK assigned to the main memory MM0 ((f) in FIG. 12). When the lock is obtained within a given time Tout, the NIC0 makes memory access to the data area DT as a processing object, and performs data processing such as the insertion, addition, or deletion of data ((g) in FIG. 12).

After performing the insertion, addition, or deletion of the data in the data area DT, the NIC0 releases the lock by resetting and initializing the lock variable LOCK assigned to the main memory MM0 (to a logical zero, for example) ((h) in FIG. 12). The data area DT in which the data processing is completed is set in an accessible state by initializing the lock variable LOCK after the completion of the data processing for the request. The NIC0 transmits a response packet including a result of performing the data processing on the data area DT to the client node SV1 ((i) in FIG. 12).

The NIC1 of the client node SV1 stores the response received from the processing node SV0 in the notification queue assigned to the main memory MM1, and transmits an interrupt notification to the CPU1 ((j) and (k) in FIG. 12). The CPU1 accesses the notification queue on the basis of the interrupt notification, and extracts the response to the RPC request ((l) in FIG. 12).

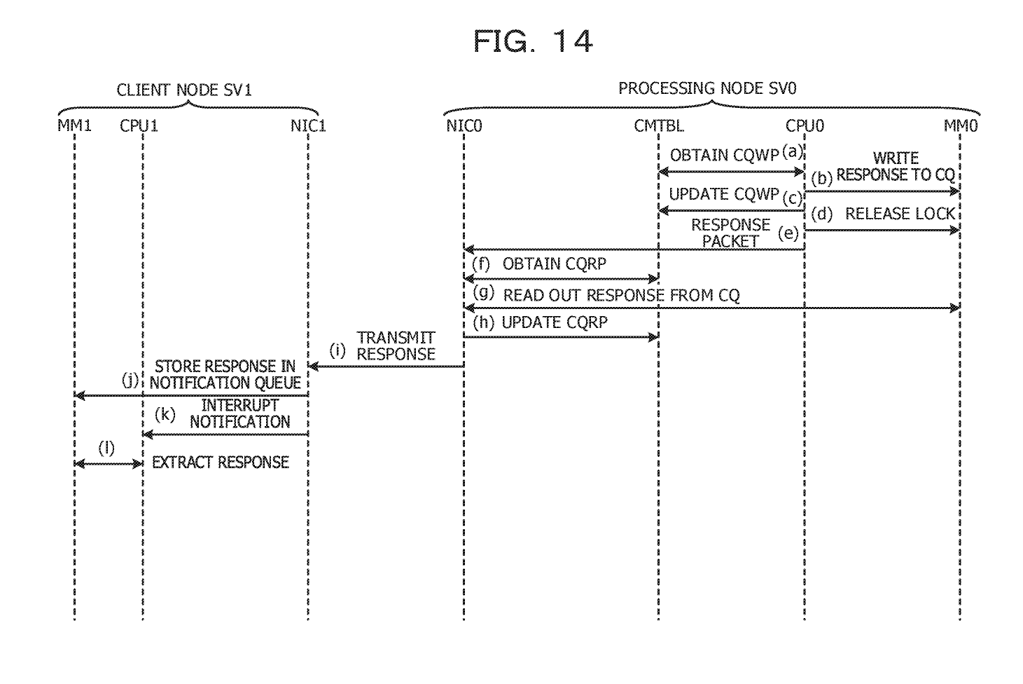

FIGS. 13 and 14 illustrate another example of operation of the information processing system SYS2 illustrated in FIG. 3. FIGS. 13 and 14 illustrate a control method of the information processing system SYS2. FIGS. 13 and 14 illustrate an example in which an RPC request is issued from the client node SV1 to the processing node SV0, a time-out occurs before the NIC0 obtains the lock, and remote procedure processing is performed by using the program of the CPU0. As in FIG. 12, the RPC request is for example a function such as the function insert( ) or push_back( ) to be processed after the obtainment of the lock. Identical or similar operations in FIGS. 13 and 14 to the operations in FIG. 12 will be omitted from detailed description. Operations of (a) to (f) in FIG. 13 are similar to the operations of (a) to (f) in FIG. 12.

In FIG. 13, the given time Tout elapses while lock obtaining operation is repeated, and therefore a time-out occurs. The NIC0 refers to the connection management table CMTBL, and obtains the write pointer RQWP of the request queue RQ ((g) in FIG. 13). The NIC0 stores the request (including the function insert( ), push_back( ), or the like) in an area of the request queue RQ which area is indicated by the write pointer RQWP in the main memory MM0, and updates the write pointer RQWP ((h) and (i) in FIG. 13). Next, the NIC0 transmits a packet indicating an interrupt notification to the CPU0 to hand over the processing of the RPC request to the CPU0 ((j) in FIG. 13).

The CPU0 starts a data processing program on the basis of the interrupt notification. Then, the CPU0 refers to the connection management table CMTBL, and obtains the read pointer RQRP of the request queue RQ ((k) in FIG. 13). The CPU0 extracts the request from the area of the request queue RQ which area is indicated by the obtained read pointer RQRP in the main memory MM0, and updates the read pointer RQRP ((l) and (m) in FIG. 13). Then, the CPU0 makes memory access to the data area DT as a processing object, and performs data processing such as insertion, addition, or deletion of data ((n) in FIG. 13).

After completing the data processing, the CPU0 obtains the write pointer CQWP of the completion queue CQ, and writes a result of the data processing (that is, a response) in an area of the completion queue CQ which area is indicated by the obtained write pointer CQWP in the main memory MM0 ((a) and (b) in FIG. 14). Next, the CPU0 updates the write pointer CQWP, and releases the lock by resetting the lock variable LOCK assigned to the main memory MM0 ((c) and (d) in FIG. 14).

The CPU0 transmits, to the NIC0, a response packet indicating that the data processing is completed ((e) in FIG. 14). On the basis of reception of the response packet from the CPU0, the NIC0 refers to the connection management table CMTBL, and obtains the read pointer CQRP of the completion queue CQ ((f) in FIG. 14). The NIC0 reads out the response from the area of the completion queue CQ which area is indicated by the read pointer CQRP in the main memory MM0, and updates the read pointer CQRP ((g) and (h) in FIG. 14). Subsequent operations of (i), (j), (k), and (l) in FIG. 14 are similar to the operations of (i), (j), (k), and (l) in FIG. 12.

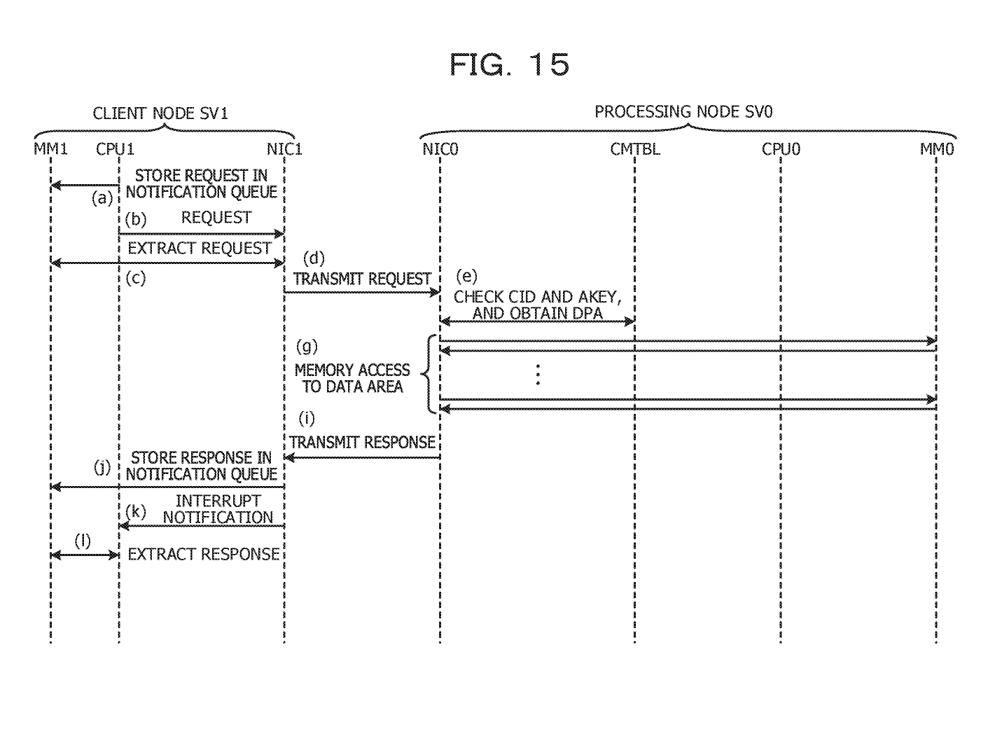

FIG. 15 illustrates yet another example of operation of the information processing system SYS2 illustrated in FIG. 3. FIG. 15 illustrates a control method of the information processing system SYS2. FIG. 15 illustrates an example in which an RPC request processable without the obtainment of the lock is issued from the client node SV1 to the processing node SV0, and the NIC0 performs remote procedure processing without using the program of the CPU0. The RPC request is for example the function front( ), back( ), size( ), or the like. Operations identical or similar to the operations in FIG. 12 will be omitted from detailed description. Operations of (a) to (e) in FIG. 15 are similar to the operations of (a) to (e) in FIG. 12.

After the NIC0 obtains the head physical address DPA of the data area DT as an operation object, the NIC0 makes memory access to the data area DT as a processing object as in (g) in FIG. 12, and performs processing of obtaining data ((g) in FIG. 15). Then, as in (i) in FIG. 12, the NIC0 transmits a response packet including the data obtained by the memory access to the data area DT to the client node SV1 ((i) in FIG. 15). Subsequent operations of (j), (k), and (l) in FIG. 15 are similar to the operations of (j), (k), and (l) in FIG. 12.

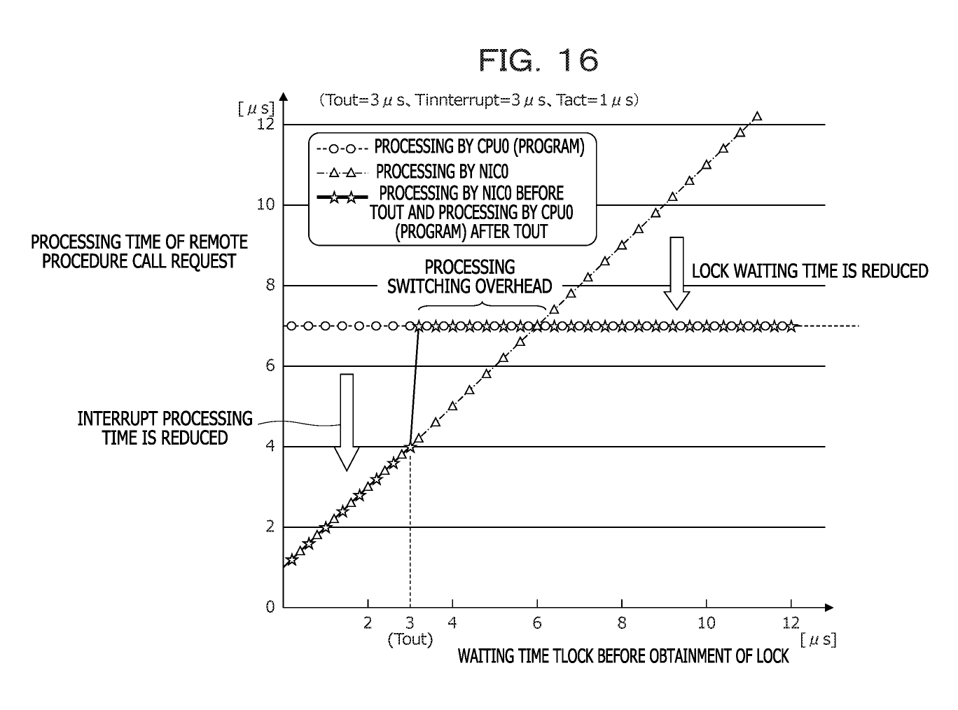

FIG. 16 illustrates an example of RPC request processing time with respect to waiting time (lock waiting time) before an NIC obtains a lock in an information processing system. The NIC and the information processing system described with reference to FIG. 16 may be the NIC0 and the information processing system SYS2 illustrated in FIG. 3. Suppose in the example illustrated in FIG. 16 that the given time Tout (time-out time) illustrated in FIG. 12 and FIG. 13 is three microseconds. Suppose that an interrupt processing time Tinterrupt from output of an interrupt notification by the NIC0 to a start of processing of a request by the program executed by the CPU0 is three microseconds.

Execution times of respective requests executed by the NIC0 and the CPU0 are different from each other, and change according to the contents of the requests. However, in the example illustrated in FIG. 16, to facilitate understanding of description, suppose that an execution time Tact taken by each of the NIC0 and the CPU0 to process a request is one microsecond. In addition, suppose that a lock waiting time Tlock before the CPU0 obtains the lock is three microseconds.

A characteristic indicated by star marks represents an example in which the NIC0 performs request processing until the lock waiting time Tlock reaches the time-out time Tout, and the CPU0 performs request processing after the lock waiting time Tlock exceeds the time-out time Tout. A characteristic indicated by triangular marks represents an example in which only the NIC0 performs RPC request processing. A characteristic indicated by circular marks represents an example in which only the CPU0 performs RPC request processing.

A processing time T1 indicated by the star marks is expressed by Equation (1). A processing time T2 indicated by the triangular marks is expressed by Equation (2). A processing time T3 indicated by the circular marks is expressed by Equation (3).

T1=T2 if (Tlock<Tout) else T3 (1)

T2=Tlock+Tact (2)

T3=Tout+Tinterrupt+Tact (3)

As illustrated in FIG. 16, the processing time (star marks) in the case where the lock waiting time Tlock is shorter than the time-out time Tout is shorter than the time of processing by only the CPU0 (circular marks). The processing time (star marks) in the case where the lock waiting time Tlock is longer than six microseconds, in which case an increase in the lock waiting time Tlock is suppressed, is shorter than the time of processing by only the NIC0 (triangular marks). Incidentally, the processing time (star marks) in the case where the lock waiting time Tlock is in a range of three microseconds to six microseconds includes overhead (mainly Tinterrupt) of switching from processing by the NIC0 to processing by the CPU0.

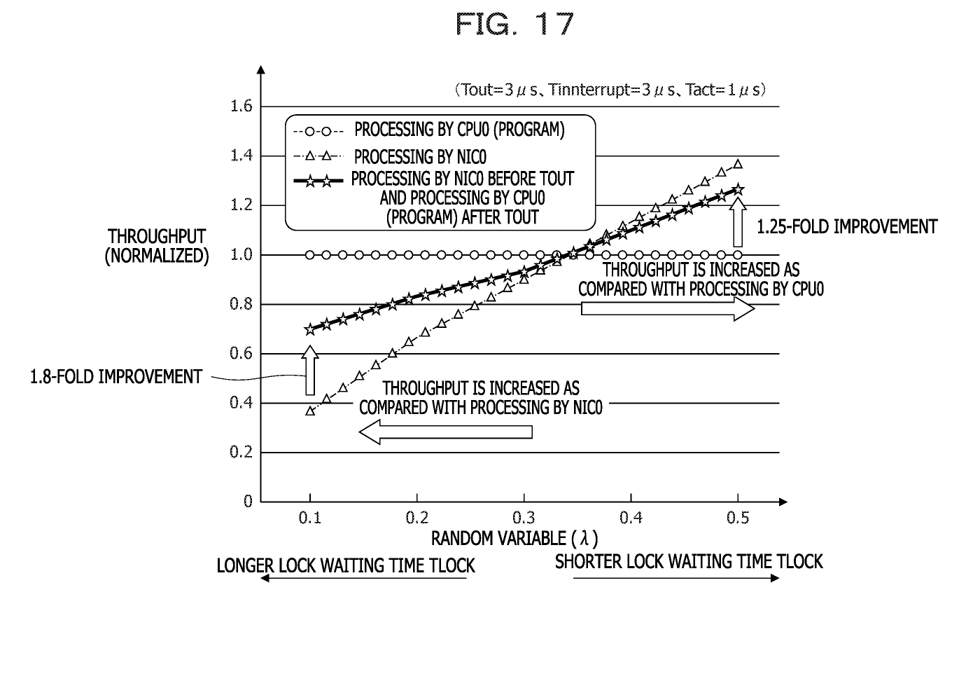

FIG. 17 illustrates an example of throughput as compared with processing by a CPU in an information processing system. The CPU and the information processing system described with reference to FIG. 17 may be the CPU0 and the information processing system SYS2 illustrated in FIG. 3. The meanings of star marks, triangular marks, and circular marks are the same as in FIG. 16. In FIG. 17, throughput in a case where RPC requests are processed by only the program executed by the CPU0 is normalized as “1.”

When the lock waiting time is in accordance with an exponential distribution, the larger a random variable (λ), the shorter the lock waiting time Tlock, and the smaller the random variable (λ), the longer the lock waiting time Tlock. In a region in which the lock waiting time Tlock is longer than the given time, throughput in the case where request processing is switched from the NIC0 to the CPU0 on the basis of a time-out is improved as compared with the case where requests are processed by only the NIC0. For example, when the random variable (λ) is 0.1, the throughput is improved 1.8 times. On the other hand, in a region in which the lock waiting time Tlock is shorter than the given time, the throughput in the case where request processing is switched from the NIC0 to the CPU0 on the basis of a time-out is improved as compared with the case where requests are processed by only the CPU0. For example, when the random variable (λ) is 0.5, the throughput is improved 1.25 times.

As described above, in the embodiment illustrated in FIGS. 3 to 17, as in the embodiment illustrated in FIG. 1 and FIG. 2, request processing efficiency is improved by processing a request in either the CPU0 or the NIC0 according to the time before the obtainment of the lock. Consequently, a decrease in performance of the information processing system SYS2 is suppressed when either the CPU0 or the NIC0 exclusively processes a request. In addition, the CPU0 or the NIC0 exclusively processes a request after obtaining the lock. The consistency of processed data is therefore ensured.

Further, in the embodiment illustrated in FIGS. 3 to 17, the decoder unit DEC00 allocates requests on the basis of the kinds of the requests. The remote procedure processing unit RCPCNT and the request processing unit RCNT0 therefore process the respective kinds of requests. In addition, control of requests is facilitated as compared with a case where the requests are processed by one processing unit.

The decoder unit DEC01 allocates responses to requests on the basis of the kinds of the responses. Thus, response processing can be performed in each of the remote procedure processing unit RCPCNT and the response receiving unit CRCV. In addition, a response to an RPC request handed over from the remote procedure processing unit RCPCNT to the CPU0 can be output to the response receiving unit CRCV. As a result, responses to RPC requests from the CPU0 can be processed by only the response receiving unit CRCV, so that control is made easier than in a case where the responses are distributed to and processed by the remote procedure processing unit RCPCNT and the response receiving unit CRCV.

The connection management table CMTBL is commonly accessible by the remote procedure processing unit RCPCNT, the request processing unit RCNT0, and the CPU0. Therefore, the remote procedure processing unit RCPCNT and the request processing unit RCNT0 can hand over the processing of a request to the CPU0 using the request queue RQ, and can receive a response to the request from the CPU0 using the completion queue CQ.

When a request can be processed without the obtainment of the lock, the remote procedure processing unit RCPCNT directly processes the request. Request processing efficiency is thereby improved as compared with a case where an interrupt is notified to the CPU0 to make the CPU0 process the request. In addition, the CPU0 can perform other processing. Thus, the processing performance of the CPU0 is improved as compared with a case where the CPU0 is made to process the request.

The lock variable LOCK is initialized after data processing for an RPC request is completed. The data area DT in which the data processing is completed is thereby set in an accessible state.

The cache coherent interface CCIF01 realizes high-speed access to data or the like as compared with a case where the cache memory CM0 is accessed via the CPU0, and maintains the coherency of the cache memory CM0.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
a first device configured to transmit a first request; and
a second device coupled to the first device, the second device including a processor configured to execute a program, a memory, and a communicating device,
wherein the communicating device is configured to:
receive the first request,
when a lock variable is not stored at a given address in the memory,
write the lock variable at the given address, and
perform processing of the first request, and
when the communicating device is unable to write the lock variable at the given address within a set time due to the lock variable stored at the given address,
notify an interrupt to the program, and
hand over the processing of the first request to the processor.

2. The system according to claim 1, wherein the communicating device includes:
a first processing circuit configured to perform the processing of the first request or hand over the processing of the first request to the processor, and
a second processing circuit configured to, based on reception of a second request different from the first request from the first device, notify an interrupt to the program, and hand over processing of the second request to the processor.

3. The system according to claim 2, wherein
the processing of the first request includes processing of accessing data within the memory via a controller controlling the memory, and
the communicating device is configured to:
identify a response from the controller in relation to access to the memory by the first processing circuit and responses to the first request and the second request executed by the processor, and
generate a response to be transmitted to the first device based on identification of the response to one of the first request and the second request, and
the first processing circuit is configured to generate a response to be transmitted to the first device based on identification of the response from the controller in relation to the access to the memory, the access to the memory being involved in the processing of the first request.

4. The system according to claim 3, wherein
the controller includes a cache memory commonly accessed by the processor and the communicating device and configured to store part of data stored in the memory, and
the communicating device includes a cache interface configured to control access to the cache memory.

5. The system according to claim 2, wherein
when a third request different from the first request is received, the first processing circuit is configured to process the third request without referring to the lock variable.

6. The system according to claim 2, wherein
the communicating device is configured to store management information including request information indicating positions at which the first request and the second request to be processed by the processor are stored in the memory and response information indicating positions at which a response to the first request processed by the processor and a response to the second request processed by the processor are stored in the memory, and
the management information is accessed by the first processing circuit, the second processing circuit, and the processor.

7. The system according to claim 2, wherein
the communicating device includes a decoder configured to identify a request received from the first device,
when the decoder identifies the received request as the first request, the first request is transferred to the first processing circuit, and
when the decoder identifies the received request as the second request, the second request is transferred to the second processing circuit.

8. The system according to claim 1, wherein
when the communicating device completes performing the processing of the first request, the communicating device is configured to initialize the lock variable written at the given address.

9. An information processing device comprising:
a processor configured to execute a program;
a memory; and
a communicating device, the communicating device being coupled to another information processing device configured to transmit a first request,
wherein the communicating device is configured to:
receive the first request,
when a lock variable is not stored at a given address in the memory,
write the lock variable at the given address, and
perform processing of the first request, and
when the communicating device is unable to write the lock variable at the given address within a set time due to the lock variable stored at the given address,
notify an interrupt to the program, and
hand over the processing of the first request to the processor.

10. The information processing device according to claim 9, wherein the communicating device includes:
a first processing circuit configured to perform the processing of the first request or hand over the processing of the first request to the processor, and
a second processing circuit configured to, based on reception of a second request different from the first request from the another information processing device, notify an interrupt to the program, and hand over processing of the second request to the processor.

11. The information processing device according to claim 10, wherein
the processing of the first request includes processing of accessing data within the memory via a controller controlling the memory, and
the communicating device is configured to:
identify a response from the controller in relation to access to the memory by the first processing circuit and responses to the first request and the second request executed by the processor, and
generate a response to be transmitted to the another information processing device based on identification of the response to one of the first request and the second request, and
the first processing circuit is configured to generate a response to be transmitted to the another information processing device based on identification of the response from the controller in relation to the access to the memory, the access to the memory being involved in the processing of the first request.

12. The information processing device according to claim 11, wherein
the controller includes a cache memory commonly accessed by the processor and the communicating device and configured to store part of data stored in the memory, and
the communicating device includes a cache interface configured to control access to the cache memory.

13. The information processing device according to claim 10, wherein
when a third request different from the first request is received, the first processing circuit is configured to process the third request without referring to the lock variable.

14. The information processing device according to claim 10, wherein
the communicating device is configured to store management information including request information indicating positions at which the first request and the second request to be processed by the processor are stored in the memory and response information indicating positions at which a response to the first request processed by the processor and a response to the second request processed by the processor are stored in the memory, and
the management information is accessed by the first processing circuit, the second processing circuit, and the processor.

15. The information processing device according to claim 10, wherein
the communicating device includes a decoder configured to identify a request received from the another information processing device,
when the decoder identifies the received request as the first request, the first request is transferred to the first processing circuit, and
when the decoder identifies the received request as the second request, the second request is transferred to the second processing circuit.

16. The information processing device according to claim 9, wherein
when the communicating device completes performing the processing of the first request, the communicating device is configured to initialize the lock variable written at the given address.

17. A method executed by a communicating device in an information processing device, the information processing device including a processor configured to execute a program and a memory, the communicating device being coupled to another information processing device configured to transmit a first request, the method comprising:
receiving the first request;
when a lock variable is not stored at a given address in the memory,
writing the lock variable at the given address, and
performing processing of the first request;
when the communicating device is unable to write the lock variable at the given address within a set time due to the lock variable stored at the given address,
notifying an interrupt to the program, and
handing over the processing of the first request to the processor.

18. The method according to claim 17, wherein the communicating device includes:
a first processing circuit configured to perform the processing of the first request or hand over the processing of the first request to the processor, and
a second processing circuit configured to, based on reception of a second request different from the first request from the another information processing device, notify an interrupt to the program, and hand over processing of the second request to the processor.

19. The method according to claim 18, wherein
the processing of the first request includes processing of accessing data within the memory via a controller controlling the memory, and
the method further comprising:
identifying a response from the controller in relation to access to the memory by the first processing circuit and responses to the first request and the second request executed by the processor; and
generating a response to be transmitted to the another information processing device based on identification of the response to one of the first request and the second request, and
the first processing circuit is configured to generate a response to be transmitted to the another information processing device based on identification of the response from the controller in relation to the access to the memory, the access to the memory being involved in the processing of the first request.

20. The method according to claim 17, further comprising:
when the communicating device completes performing the processing of the first request, initializing the lock variable written at the given address.
